(19) United States
(12) Patent Application Publication
(10) Pub. No.: US 2004/0077379 A1
(43) Pub. Date: Apr. 22, 2004

(54) Wireless transmitter, transceiver and method

(76) Inventors: Martin Smith, Chelmsford (GB); Sonya V. Arnos, Bishops Stortford (GB); Andrew Urguhart, Bishops Stortford (GB)

Correspondence Address: BARNES & THORNBURG, P.O. BOX 2786, CHICAGO, IL, 60690-2786, US

(21) Appl. No.: 10/683,035

(22) Filed: Oct. 10, 2003

Related U.S. Application Data
(63) Continuation-in-part of application No. 10/180,502, filed on Jun. 27, 2002.
(60) Provisional application No. 60/447,643, filed on Feb. 14, 2003.
(60) Provisional application No. 60/446,617, filed on Feb. 12, 2003.
(60) Provisional application No. 60/446,618, filed on Feb. 12, 2003.
(60) Provisional application No. 60/488,456, filed on Jul. 18, 2003.
(60) Provisional application No. 60/480,599, filed on Jun. 20, 2003.
(60) Provisional application No. 60/467,432, filed on May 2, 2003.
(60) Provisional application No. 60/464,844, filed on Apr. 23, 2003.
(60) Provisional application No. 60/461,579, filed on Apr. 9, 2003.
(60) Provisional application No. 60/461,344, filed on Apr. 9, 2003.
(60) Provisional application No. 60/454,715, filed on Mar. 15, 2003.
(60) Provisional application No. 60/453,840, filed on Mar. 11, 2003.
(60) Provisional application No. 60/453,011, filed on Mar. 7, 2003.
(60) Provisional application No. 60/451,897, filed on Mar. 4, 2003.
(60) Provisional application No. 60/447,646, filed on Feb. 14, 2003.
(60) Provisional application No. 60/447,645, filed on Feb. 14, 2003.
(60) Provisional application No. 60/447,644, filed on Feb. 14, 2003.
(60) Provisional application No. 60/447,527, filed on Feb. 14, 2003.
(60) Provisional application No. 60/446,619, filed on Feb. 12, 2003.

(51) Int. Cl. H04B 1/38

(52) U.S. Cl. 455/562.1; 455/561

(57) ABSTRACT

Provided is an antenna adapted to transmit a first channel on at least two adjacent fixed beams of a plurality of fixed beams defining a coverage area, with each pair of adjacent fixed beams of the plurality of fixed beams partially overlapping and having substantially orthogonal polarizations. The antenna has a respective transmitter adapted to transmit on each of the plurality of fixed beams a respective unique composite signal, each composite signal containing said first channel and a respective unique traffic channel.

### R LATED APPLICATIONS

This application is a Continuation In Part of U.S. patent application Ser. No. 10/180,502; filed Jun. 27, 2002 and also claims priority from U.S. Provisional Patent Application 60/447,643 filed Feb. 14, 2003, which is incorporated herein by reference.

### CROSS-REFERENCE TO RELATED APPLICATIONS

This patent application is related to the following Provisional patent applications filed in the U.S. Patent and Trademark Office, the disclosures of which are expressly incorporated herein by reference:

U.S. Patent Application Serial No. 60/446,617 filed on Feb. 11, 2003 and entitled “System for Coordination of Multi Beam Transit Radio Links for a Distributed Wireless Access System” [15741]

U.S. Patent Application Serial No. 60/446,618 filed on Feb. 11, 2003 and entitled “Rendezvous Coordination of Beamed Transit Radio Links for a Distributed Multi-Hop Wireless Access System” [15743]

U.S. Patent Application Serial No. 60/446,619 filed on Feb. 12, 2003 and entitled “Distributed Multi-Beam Wireless System Capable of Node Discovery, Rediscovery and Interference Mitigation” [15742]

U.S. Patent Application Serial No. 60/447,527 filed on Feb. 14, 2003 and entitled “Cylindrical Multibeam Planar Antenna Structure and Method of Fabrication” [15907]

U.S. Patent Application Serial No. 60/447,644 filed on Feb. 14, 2003 and entitled “Antenna Diversity” [15913]

U.S. Patent Application Serial No. 60/447,645 filed on Feb. 14, 2003 and entitled “Wireless Antennas, Networks, Methods, Software, and S rvices” [15912]

U.S. Patent Application Serial No. 60/447,646 filed on Feb. 14, 2003 and entitled “Wireless Communication” [15897]

U.S. Patent Application Serial No. 60/451,897 filed on Mar. 4, 2003 and entitled “Offsetting Patch Antennas on an Omni-Directional Multi-Facetted Array to allow Space for an Interconnection Board” [15958]

U.S. Patent Application Serial No. 60/453,011 filed on Mar. 7, 2003 and entitled “Method to Enhance Link Range in a Distributed Multi-hop Wireless Network using Self-Configurable Antenna” [15946]

U.S. Patent Application Serial No. 60/453,840 filed on Mar. 11, 2003 and entitled “Operation and Control of a High Gain Phased Array Antenna in a Distributed Wireless Network” [15950]

U.S. Patent Application Serial No. 60/454,715 filed on Mar. 15, 2003 and entitled “Directive Antenna System in a Distributed Wireless Network” [15952]

U.S. Patent Application Serial No. 60/461,344 filed on Apr. 9, 2003 and entitled “Method of Assessing Indoor-Outdoor Location of Wireless Access Node” [15953]

U.S. Patent Application Serial No. 60/461,579 filed on Apr. 9, 2003 and entitled “Minimisation of Radio Resource Usage in Multi-Hop Networks with Multiple Routings” [15930]

U.S. Patent Application Serial No. 60/464,844 filed on Apr. 23, 2003 and entitled “Improving IP QoS though Host-Based Constrained Routing in Mobile Environments” [15807]

U.S. Patent Application Serial No. 60/467,432 filed on May 2, 2003 and entitled “A Method for Path Discovery and Selection in Ad Hoc Wireless Networks” [15951]

U.S. Patent Application Serial No. 60/468,456 filed on May 7, 2003 and entitled “A Method for the Self-Selection of Radio Frequency Channels to Reduce Co-Channel and Adjacent Channel Interference in a Wir less Distributed N tw rk” [16101]

U.S. Patent Application Serial No. 60/480,599 filed on Jun. 20, 2003 and entitled “Channel Selection” [16146]

### FIELD OF THE INVENTION

This invention relates in general to cellular communication systems and in particular to wireless transmitters, transceivers and methods.

### BACKGROUND OF THE INVENTION

In order to satisfy the demand for transmission capacity within an available frequency band allocation, digital cellular systems divide a particular geographic area to be covered into a number of cell areas. A cell consists of a base station from which mobile units within the cell access the cellular system. It is the base station capacity that typically defines the optimal cell coverage area. The capacity of a base station is ideally as large as possible so that each cell can serve as an access point to the cellular system to as many mobile units as possible over a large area.

One method of achieving an increase in capacity is to replace a wide beamwidth antenna with an antenna array that provides a number of narrower beamwidth beams that cover the area of the original beam. Referring to FIG. 1, a conventional wireless communication cell 100 is shown comprising three adjacent sectors, alpha 102, beta 104 and gamma 106. Each cell comprises an antenna tower platform 120 located at the intersection of the three sectors. The antenna tower platform 120 has three sides forming an equal-lateral triangle. Each sector has three antennas, (only antennas in sector alpha 102 are shown) a first antenna 114, a second antenna 116, and a third antenna 112 mounted on a side of the antenna tower platform 120. The three antennas of each sector produce a corresponding set of three beams (only beams in sector alpha 102 are shown) including a first beam 108, a second beam 110 and a third beam 112. The three beams 108, 110, 112 are adjacent with some overlap. The three sectors alpha 102, beta 104 and gamma 106 are identical in structure with respect to antennas and beams. The signal for a particular user can then be sent and received only over the beam or beams that are useful for that user. If the pilot channel on each beam is unique (e.g. has a different PN (pseudo-random noise) offset) within each sector then the increase in capacity is limited due to interference between reused pilot channels in different cells.

An improvement is to use multiple narrow beams for the traffic channels and transmit the overhead channels (pilot, synch, and paging channels) over the whole sector so that the overhead channels are common to all the narrow beams used by the traffic channels in that sector. This leads to substantial gains in capacity. It is therefore desirable that the overhead channels be broadcast over the area covered by the original wide beam. There may alternatively be separate broadcast channels which it is desirable to broadcast over the area covered by the original wide beam.

Broadcasting the overhead channels over an entire sector can be accomplished by using the original wide beam antenna or by transmitting the overhead channels synchronously using the same multiple narrow beams used to transmit and receive the traffic channels. However, a problem common to both of these arrangements is that both require the expense of extra hardware, complex calibration equipment and algorithms to match the phases of the overhead channels to the phases of the traffic channels.

Currently, multiple beams of one polarization are used to provide coverage for a single sector, with a second polarization used for diversity purposes. When a full sector transmission is required, as for the overhead channels, transmission of identical signals on all beams simultaneously can create spatial interference nulls at the beam crossover points, assuming that the equipment has not been carefully calibrated (so the relative phases are not controlled). An approach that is proposed in commonly assigned U.S. patent application Ser. No. 09/733,059, entitled “Antenna Systems With Common Overhead For CDMA Base Stations” and filed on Dec. 11, 2000 by McGowan et al, provides a method of phase cycling of the beams to ensure that a spatial null only persists for a short duration of time.

There is thus a desire to provide an antenna array that uses fixed narrow beams for transmitting and receiving the traffic channels on multiple beams and may broadcast the common pilot channel over all of the sector using the same antenna array. Furthermore, it would be advantageous to provide an antenna system that did not require complex calibration and adjustment to maintain performance over time and temperature.

### SUMMARY OF THE INVENTION

Advantageously, embodiments of the invention allow the distinctive interference which would otherwise occur when transmitting the same signal on overlapping beams is avoided through the use of orthogonal polarizations.

According to one aspect, the invention provides an antenna forming a first plurality of fixed beams defining a coverage area, wherein each pair of adjacent fixed beams of said plurality of fixed beams are partially overlapping and have substantially orthogonal polarizations.

In some embodiments, the antenna is further adapted to transmit a first channel on at least two adjacent fixed beams.

In some embodiments, the antenna further comprises a respective transmitter adapted to transmit on each of said first plurality of fixed beams a respective unique composite signal, each composite signal comprising said first channel and a respective at least one unique traffic channel.

In some embodiments, the antenna further comprises the antenna adapted to transmit CDMA signals.

In some embodiments, the antenna further comprises a respective receiver coupled to receive a respective receive signal over each of said first plurality of fixed beams.

In some embodiments, the antenna comprises a dual polarization array adapted to produce all of the beams of the first and second pluralities of beams.

In some embodiments, the antenna is further adapted to receive over a second plurality of fixed beams comprising a corresponding fixed beam for each fixed beam of said first plurality of fixed beams which is substantially coextensive with the fixed beam of the first plurality of fixed beams and has a respective polarization which is substantially orthogonal to the polarization of the fixed beam of the first plurality of fixed beams.

In some embodiments, the respective polarization of each of the first and second plurality of fixed beams is one of two substantially orthogonal polarizations.

In some embodiments, the respective polarization of each of the first and second plurality of fixed beams is one of two substantially orthogonal polarizations, and each of the beams from both the first and second plurality of fixed beams are preferably transmitted from a single dual polarization antenna array capable of providing two substantially orthogonal polarizations simultaneously.

In some embodiments, the antenna further comprises a first antenna array and a second antenna array, the first antenna array being adapted to produce each fixed beam of said first and second plurality of fixed beams having a first of said two substantially orthogonal polarizations and the second antenna array being adapted to produce each fixed beam of said first and second plurality of fixed beams having a second of said two substantially orthogonal polarizations.

In some embodiments, the antenna further comprises a first multiple fixed beam former connected to the first antenna array and a second multiple fixed beam former connected to the second antenna array.

In some embodiments, the antenna further comprises a fixed beam forming matrix connected to the first antenna array and the second antenna array.

In some embodiments, the antenna further comprises a respective receiver coupled to receive for each of said first and second pluralities of fixed beams a respective receive signal over the fixed beam.

In some embodiments, the antenna further comprises a respective receiver coupled to receive for each of said first and second pluralities of fixed beams a respective receive signal over the fixed beam.

In some embodiments, the antenna further comprises for each pair of fixed beams comprising a fixed beam of said first plurality of the corresponding fixed beam of the second plurality of antennas, a respective combiner adapted to perform diversity combining of the receive signals received over the pair of fixed beams.

In some embodiments, the antenna further comprises for each pair of fixed beams comprising a fixed beam of said first plurality of the corresponding fixed beam of the second plurality of antennas, a respective combiner adapted to perform diversity combining of the receive signals received over the pair of fixed beams.

In some embodiments there is provided an antenna for forming an omni directional beam comprising a plurality of antenna elements arranged around a structure, wherein each said element or collection of elements forms a one of said first plurality of beams.

Each said beam may be a directional beam.

In some embodiments each said element is arranged at substantially equal angular spacing around said structure.

The antenna maybe capable of forming a polarisation diverse omni directional beam, further comprising a switch element capable of changing the polarisation of each directional beam between two orthogonal polarisations.

According to a further aspect of the present invention there is provided an antenna comprising: a plurality of antenna elements arranged around a structure; and a switching element for switching between a first and a second beam arrangement, wherein said first beam arrangement is a directional multiple beam pattern and said second beam arrangement is an omni directional beam pattern.

According to a further aspect of the present invention there is provided an omni directional beam pattern comprising: a plurality of beams formed by an antenna arranged around a structure, and wherein adjacent beams have orthogonal polarisation.

According to a further aspect of the present invention there is provided a complex switch for switching between a first and a second input and a sum of said first and second inputs wherein the switch includes four switching elements and a combining element, arranged with no cross over portions.

The invention also provides for a system for the purposes of communications which comprises one or more instances of antenna embodying the present invention, together with other additional apparatus.

The invention is also directed to methods by which the described apparatus operates and including method steps for carrying out every function of the apparatus.

The invention also provides for computer software in a machine-readable form and arranged, in operation, to carry out every function of the apparatus and/or methods.

According to a further aspect of the present invention there is provided a method of forming an omni directional polarisation diverse beam pattern comprising the steps of: forming a plurality of beams from an antenna arranged around a structure.

According to another aspect, the invention provides a method which involves transmitting a first channel on at least two adjacent fixed beams of a first plurality of fixed beams defining a coverage area, with each pair of adjacent fixed beams of said plurality of fixed beams partially overlapping and having substantially orthogonal polarization.

In some embodiments, the method further comprises transmitting on each of said first plurality of fixed beams a respective unique composite signal, each composite signal comprising said first channel and a respective at least one unique traffic channel.

In some embodiments, the first channel is a CDMA signal.

In some embodiments, the method further comprises receiving a respective receive signal over each of first said plurality of fixed beams.

In some embodiments, the method further comprises receiving a respective receive signal over each of a second plurality of fixed beams comprising a corresponding fixed beam for each fixed beam of said first plurality of fixed beams which is substantially co-extensive with the fixed beam of the first plurality of fixed beams, and has a respective polarization which is substantially orthogonal to the polarization of the fixed beam of the first plurality of fixed beams.

In some embodiments, the respective polarization of each of the first and second plurality of fixed beams is one of two substantially orthogonal polarizations.

In some embodiments, the method further comprises receiving a respective receive signal over each of said first plurality of fixed beams.

In some embodiments, the method further comprises performing, for each pair of fixed beams comprising a fixed beam of said first plurality of the corresponding fixed beam of the second plurality of antennas, diversity combining of the receive signals received over the pair of fixed beams.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

The invention will now be described in greater detail with reference to the accompanying diagrams, in which:

FIG. 1 is a diagram of a conventional wireless communication cell;

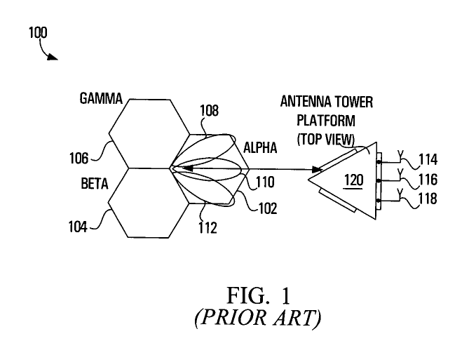

FIG. 2 is a schematic of wireless transmission system provided by an embodiment of the invention;

FIG. 3 is a schematic of a wireless transceiver system provided by an embodiment of the invention; and

FIG. 4 is a plot of an example antenna power radiation pattern of the wireless transceiver in FIG. 2.

FIG. 5 shows a schematic diagram of antenna coverage;

FIG. 6 shows a schematic diagram of a cylindrical multibeam antenna;

FIG. 7 shows a schematic diagram of a beam pattern of a multibeam antenna;

FIG. 8 shows a schematic diagram of the angular spacing of elements of a multibeam antenna;

FIG. 9 shows a schematic diagram of the angular spacing of elements of an omnidirectional antenna;

FIG. 10 shows a schematic diagram of the angular power of an omnidirectional antenna;

FIG. 11 shows a schematic diagram of the angular power of an omnidirectional antenna without phase control;

FIG. 12 shows a schematic diagram of an omnidirectional antenna according to the present invention;

FIG. 13 shows a schematic diagram of angular spacing of elements of an omnidirectional antenna according to the present invention;

FIG. 14 shows a schematic diagram of a beam pattern of an omnidirectional antenna according to the present invention;

FIG. 15 shows a schematic diagram of polarisation diversity in an omnidirectional antenna according to the present invention;

FIG. 16 shows a schematic diagram of angular power of an omnidirectional antenna according to the present invention;

FIG. 17 shows a schematic diagram of angular power of an omnidirectional antenna according to the present invention;

FIG. 18 shows a schematic diagram of angular power of an omnidirectional antenna without phase control according to the present invention;

FIG. 19 shows a schematic diagram of angular power of an omnidirectional antenna without phase control according to the present invention;

FIG. 20 shows a schematic diagram of switch architecture for multibeam antennas;

FIG. 21 shows a schematic diagram of switch architecture for multibeam antennas;

FIG. 22 shows a schematic diagram of a switching unit according to the present invention;

FIG. 23 shows a schematic diagram of switch architecture for multibeam antennas according to the present invention;

FIG. 24 shows a schematic diagram of switch architecture for multibeam antennas according to the present invention.

### DETAILED DESCRIPTION OF THE PREFERRED EMBODIMENTS

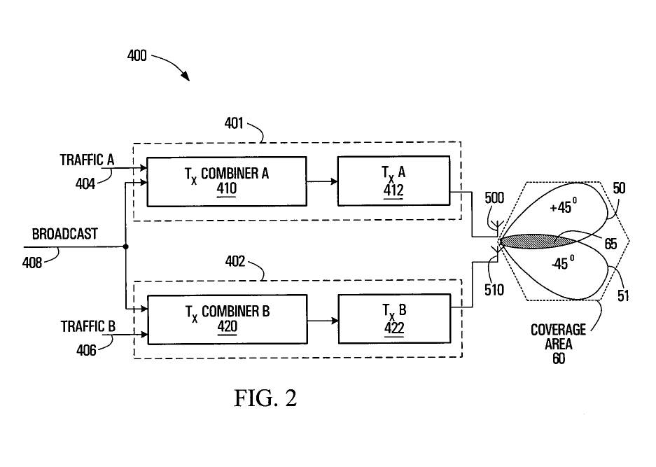

In order to transmit unique traffic channels on each beam in a coverage area while simultaneously transmitting common overhead or overhead channels (e.g. pilot, sync, and paging channels) over all of the beams in the coverage area, a wireless transmission system using fixed beams that does not require complex calibration equipment and algorithms is provided. FIG. 2 illustrates a wireless transmission system 400 provided by an embodiment of the invention that may be deployed within a coverage area 60.

The wireless transmission system 400 has a first transmission signal chain 401 and a second transmission signal chain 402. The first transmission signal chain 401 has in series a transmission signal combiner A 410, a transmitter A 412 and an antenna 500. Similarly, the second transmission signal chain 402 has a transmission signal combiner B 420, a transmitter B 422 and an antenna 510. It would be understood by those skilled in the art that an additional combination of hardware, software and firmware would be required to support the wireless transmission system 400 to make it operable. Illustrated in FIG. 2 are only those components necessary to discuss aspects of the invention.

The wireless transmission system 400 operates to cover the coverage area 60 with two fixed beams 50 and 51 originating from transmission signal chains 401 and 402 respectively. At least one unique traffic channel is transmitted through each transmission signal chain 401 and 402. Simultaneously, both transmission signal chains 401 and 402 transmit a common overhead channel so that the overhead channel can be received anywhere within the coverage area 60. Within each transmission signal chain 401 and 402 at least one unique traffic channel is combined with the common overhead channel in the respective transmission signal combiners 410 and 420 before transmission via the fixed beams 50 and 51 respectively.

Referring to the example illustrated in FIG. 2, the transmission signal chain 401 is used to transmit a first unique traffic channel TRAFFIC A 404 and the common overhead channel BROADCAST 408 and the transmission signal chain 402 is used to transmit a second unique traffic channel TRAFFIC B 406 and the common overhead channel BROADCAST 408. The fixed beams 50 and 51 are launched from antennas 500 and 510 respectively. It should be stressed that the at least one unique traffic channel transmitted through each transmission signal chain 401 and 402 can only be received in the region of the coverage area 60 that is covered by the fixed beams 50 and 51 respectively. That is, traffic channel TRAFFIC A can only be received in the region of the coverage area covered by fixed beam 50 and the same is true for traffic channel TRAFFIC B and fixed beam 51. However, since the combination of fixed beams 50 and 51 provide coverage to the entire coverage area 60, the common overhead channel BROADCAST 408 can be received everywhere within the coverage area 60.

In order to avoid any destructive combination of the simultaneous transmissions containing the common overhead channel in an area 65 where the two fixed beams 50 and 51 overlap, the fixed beam 50 is launched with a transmission polarization orthogonal to that of the fixed beam 51. For example beam 50 could be transmitted with 45° polarization, and beam 51 could be transmitted with −45° polarization. The combination of the received signals from the two beams 50,51 in their overlap region 65 will have a variable polarization but will almost never see destructive interference of the magnitude that would substantially lead to the cancellation of the power of the received signal in the overlap region 65. Polarization mismatch with the mobile antenna may occur, but this is no different to a full sector single polarization transmission system with polarization mixing in the propagation path. In other words, a sector covered by a single wide-beam would also be influenced by polarization mismatch between the base station antenna and the mobile antenna.

FIG. 2 provides a single example embodiment of the invention. More generally, an embodiment of the invention provide for a coverage area in which an arbitrary number of fixed beams are employed, each fixed beam having a launch (transmission) polarization that is substantially orthogonal to the adjacent fixed beams. Individual traffic channels are sent on each beam, and a common overhead channel is sent on all beams, or more generally at least two of the beams. The result will be that within the region where the adjacent fixed beams overlap there will be only minimal signal degradation to the common signal channel transmitted on adjacent beams due to destructive combination of the common signal channel received from adjacent beams.

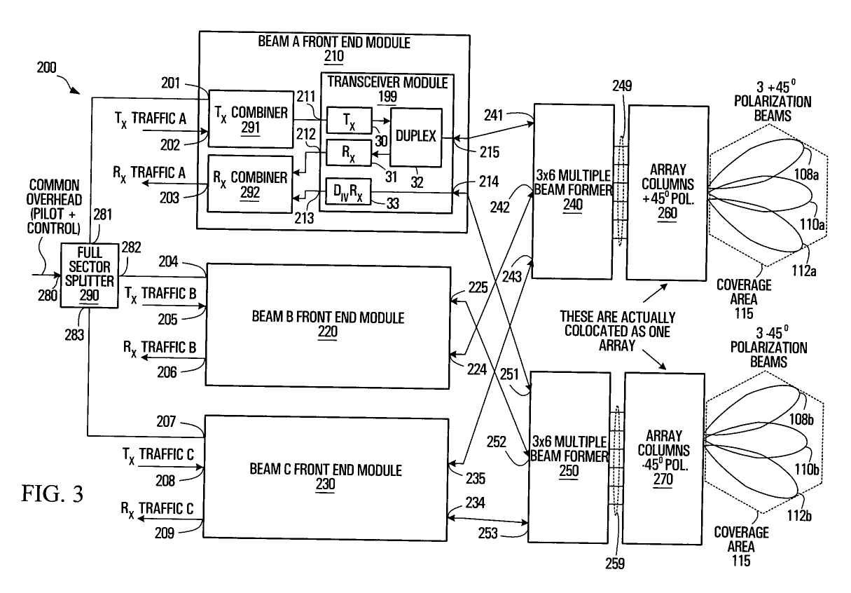

FIG. 3 illustrates a more detailed example of a wireless transceiver system 200 that may be deployed within a coverage area according to an embodiment of the invention that operates to provide sector wide coverage for the overhead channels on the downlink and reception diversity on the uplink.

The system 200 of FIG. 3 has a full sector splitter 290 connected to receive a common overhead signal 280 which might for example be some combination of pilot and control information. The common overhead signal is input to each of three beam front end modules, namely beam A front end module 210, beam B front end module 220, and beam C front end module 230. The beam front end modules are detailed below.

Each beam front end module is also connected to receive a respective transmit traffic signal. Thus, beam A front end module receives at input port 202 Tx traffic A, beam B front end module receives at input port 204 Tx traffic B, and beam C front end module 230 receives at input port 208 Tx traffic C. Each beam front end module also outputs a respective receive traffic signal. Thus, beam A front end module outputs at output port 203 Rx traffic A, beam B front end module outputs at output port 206 Rx traffic B, and beam C front end module 230 outputs at output port 209 Rx traffic C.

Each of the beam front end modules is connected bi-directionally to a respective input beam-port of each of two multiple beam formers 240,250. More specifically, beam A front end module 210 output 215 is connected bi-directionally to beam-port 241 of the first multiple beam former 240, and beam A front end module 210 output 214 is connected bi-directionally to beam-port 251 of the second multiple beam former 240. Similarly, beam B front end module 220 output 225 is connected bi-directionally to beam-port 242 of the first multiple beam former 240, and beam B front end module 220 output 224 is connected bi-directionally to beam-port 252 of the second multiple beam former 240. Finally, beam C front end module 230 output 235 is connected bi-directionally to beam-port 243 of the first multiple beam former 240, and beam C front end module 230 output 234 is connected bi-directionally to beam-port 253 of the second multiple beam former 240.

Each of the multiple beam formers 240, 250 is connected to a respective antenna array 260, 270 through respective sets of antenna ports 249 and 259. The first antenna array 260 operates to provide a coverage area 115 with a first set of three fixed beams 108a, 110a, 112a at +45° polarization. Similarly, the second antenna array 270 operates to provide the same coverage area 115 with a second set of three fixed beams 108b, 110b, 112a at −45° polarization which are each substantially coextensive with corresponding beams of the first set of three fixed beams. More generally, any orthogonal polarizations may be employed.

The details of the beam A front end module 210 will now be described by way of example, the other two beam front end modules being the same. Beam A front end module 210 has a Tx combiner 291 which operates to combine the common overhead signal and the Tx traffic A signal and output this to an input 211 of a transceiver module 199 which connects to a transmitter component 30 within the transceiver module 199. The transmitter component 30 is connected through a duplexer 32 in the forward direction to beam-port 241 of the first multiple beam former 240. In the reverse direction, beam-port 241 of the first multiple beam former 240 is connected through the duplexer 32 to a receiver component 30 in the transceiver module 199 an output 212 of which is connected to an Rx combiner 292. The duplexer 32 operates to select a transmission signal band or receive signal band for the appropriate routing of Tx and Rx signals through the transceiver module 199. The transceiver module 199 also has a diversity receiver component 33 which connects the first beam-port 251 of the second multiple beam former to the Rx combiner 292.

Beam B front end module 220 is connected in the same manner, excepting that its diversity receive signals will be received from beam-ports 242 and 252 of the first and second multiple beam formers 240, and its transmit signals will be output to beam-port 252 of the second multiple beam former. Similarly, Beam C front end module 230 is connected in the same manner, excepting that its diversity receive signals will be received from beam-ports 243 and 253 of the first and second multiple beam formers 240, 250 and its transmit signals will be output to beam-port 242 of the first multiple beam former. It can be seen in the static configuration of FIG. 3 that in fact, beam-ports 251, 242 and 253 do not need to be bi-directional since these are only used for receive signals.

Although the present embodiment has been described as having two antenna arrays providing two sets of co-extensive fixed-beams such that each set of fixed beams has a substantially orthogonal polarization to the other set of fixed-beams, in another embodiment the two sets of fixed-beams are provided by a single dual polarization antenna array capable of providing two sets of co-extensive fixed beams that are substantially orthogonal in terms of their respective polarizations.

In operation, in the forward direction, the common overhead signal 280 is sent to each of the three beam front end modules 210, 220, 230 and is transmitted on beam 108a, 110b and 112a. Adjacent beams of this set have orthogonal polarization so that destructive interference is avoided. Tx traffic A is transmitted only on beam 108a. Tx traffic B is transmitted only on beam 110b, and Tx traffic C is transmitted only on beam 112a.

In the reverse direction, signals received on coextensive fixed beams 108a and 108b, are combined in the diversity combiner 292 of the beam A front end module 210 and output as Rx traffic A.

Similarly, signals received on coextensive fixed beams 110a and 110b are combined in the diversity combiner (not shown) of the beam B front end module 220 and output as Rx traffic channel B.

Finally, signals received on coextensive beams 112a and 112b are combined in the diversity combiner (not shown) of the beam C front end module 230 and output as Rx traffic channel C.

It is noted that Rx traffic channel A may contain signal content from mobile units in the area of beams 108a, 108b, but may also contain signal content from mobile units, either in the area of beams 110a, 110b where they overlap with beams 108a, 108b or in areas where obstructions result in multipath, and a similar situation exists for the other received traffic signals. Upstream processing (not shown) may be provided to resolve these signals if necessary.

The multiple beam formers operate to simultaneously direct a Tx signal received into one of its beam-ports to one of the three fixed beams provided by the antenna array. The fixed beam selected is dependent upon which beam-port the Tx signal is received into. For example, the multiple beam former 240 will direct the Tx signal received into beam-port 241 onto fixed beam 108a by way of amplitude and phase shaping, while simultaneously directing the Tx signal received into beam-port 243 onto fixed beam 112a. Similarly, multiple beam former 250 will direct a Tx signal received into beam-port 252 onto fixed beam 110b. Beam-ports 241, 252 and 243 are also able to send Rx signals in the reverse direction after these Rx signals have been coupled from fixed beams 108a, 110b and 112a respectively. As mentioned above, beam-ports 251, 242 and 253 are only used for receive signals and thus only receive Rx signals coupled from fixed beams 108b, 110a and 112b respectively.

Additionally, information originally scheduled to by transmitted on Tx traffic A could be re-routed by backend electronics (not shown) onto Tx traffic B (or Tx traffic C) if the mobile receiver has moved into the coverage area of a different beam. Similar re-routing could be done for Tx traffic B and Tx traffic C.

Although two antenna arrays forming three beams per polarization per sector are used in this example of the preferred embodiment, any number of beams and antenna arrays per sector greater than one may be used while remaining within the scope of the invention.

The received signal strength of a pilot channel (or any other overhead channel, e.g., a control channel) at any point in the coverage area is determined by the vector sum of all pilot channel signals received from each beam. Both the wireless transmission system 400 and the wireless transceiver system 200 provide systems in which adjacent beams are preferably of alternating polarizations. A coverage area, such as a sector of a cell, covered by adjacent narrow beams with alternating polarizations results in a combined radiation pattern in the coverage area that is substantially a constant amplitude but has an undetermined polarization. In other words, alternating polarization combines beams with orthogonal polarizations, having unknown relative phase, that in turn produce a combined radiation pattern having a substantially constant amplitude across the sector; however, the polarization of the combined radiation pattern is variable. The relative phases are unknown since no effort has been made to calibrate the internal connections of the components that comprise the wireless transceiver system 200 and the wireless transmission system 400. The lack of calibration results from internal signal paths that have uncontrolled phase delays. However, this is the situation the invention is intended to operate within since calibration is a lengthy and costly installation feature in a wireless system, and avoiding it would be desirable. The invention would of course still work if such calibration efforts were made.

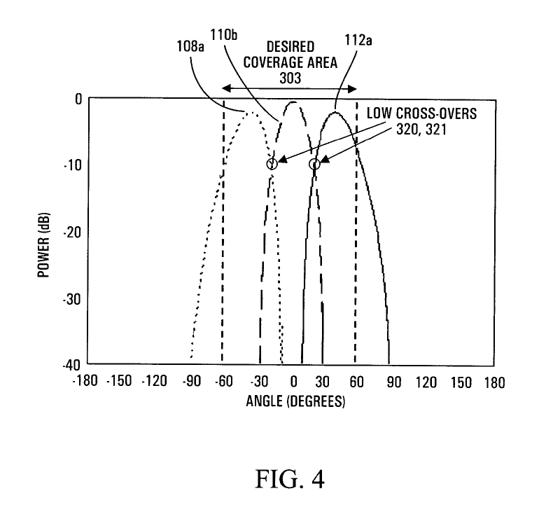

FIG. 4 shows a simulated radiation pattern for the wireless transceiver system 200 illustrated in FIG. 3 for the three adjacent beams 108a, 110b and 112a. Considering the first beam 108a and second beam 110b having +45 degree polarization and −45 degree polarization respectively, the effect of varying the relative phase is that the resultant polarization varies anywhere from being completely in phase to completely anti-phase at the low cross over 320. Thus, there is always power at the crossover angle, but the polarization is uncontrolled. This is not a problem since it is the power of the received signal that is important not its received polarization. A similar situation exists at the low cross over 321 for the beams 110b and 112a.

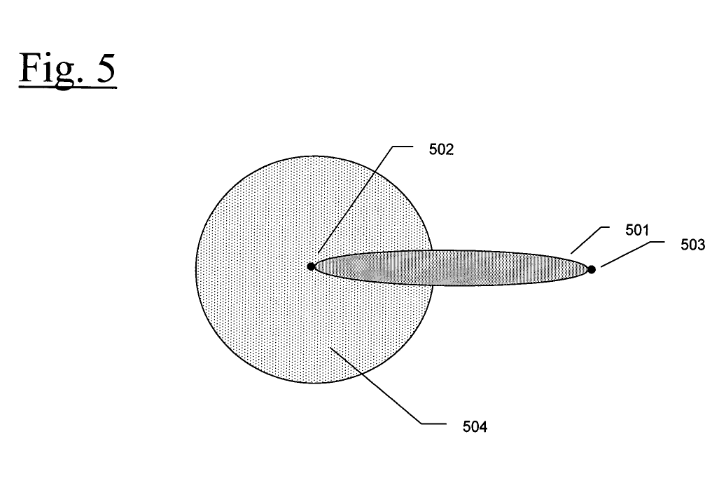

Other embodiments of the present invention are described below with reference to FIGS. 5-24.

As described earlier, within a wireless communication networks it may be necessary or beneficial to have both directional transmission 501, from a node 502 to another node 503, and broadcast transmission from the node 501 to any receiving equipment within the coverage area 504, as shown in FIG. 5.

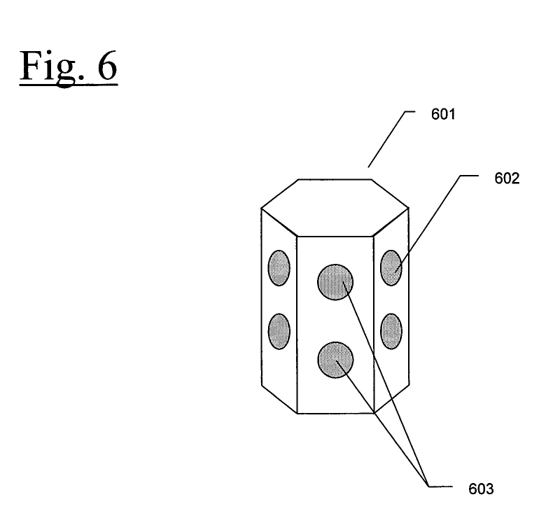

To provide directional transmission, a cylindrical multibeam antenna has been developed, as shown in FIG. 6, and this antenna is disclosed in the following co-pending U.S. Provisional Patent Applications:

Nortel reference 158971D: Damian Bevan, Steve Baines and Simon Gale entitled “Wireless Communication”, U.S. Patent Application No. 60/447,646 filed Feb. 14, 2003.

Nortel reference 159071D: Martin Smith and Andrew Urquhart entitled “Cylindrical Multibeam Planar Antenna Structure and Method of Fabrication”, U.S. Patent Application No. 60/447,527 filed Feb. 14, 2003.

Nortel reference 159121D: Martin Smith, Chris Ward, Damian Bevan et al entitled “Wireless Antennas, Networks, Methods, Software and Services”, U.S. Patent Application No. 60/447,647 filed Feb. 14, 2003.

FIG. 6 shows a 6 beam antenna 601 comprising individual antenna elements 602 arranged in columns 603.

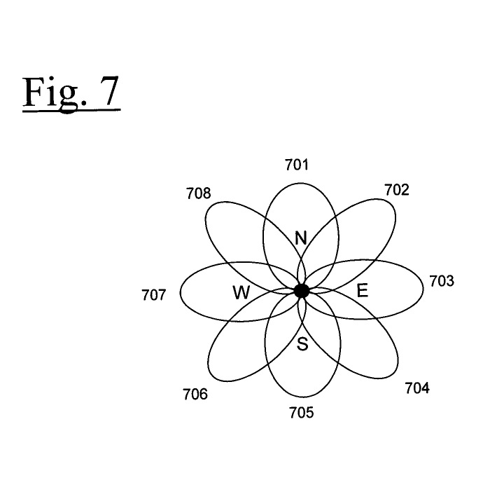

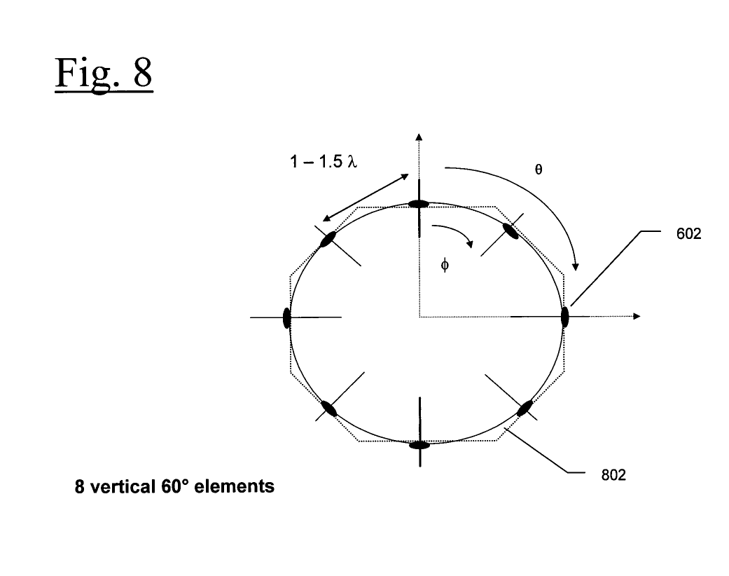

FIG. 7 shows a schematic diagram of a beam pattern of such a multibeam antenna having 8 overlapping beams 701-708. To achieve this beam pattern, 8 antenna elements 602 are arranged at equal angular spacing of 45° on the circumference of a circle 802, as shown in FIG. 8. The antenna elements are typically separated by a distance of 1-1.5 times the wavelength (λ) used in order to allow a minimum cost construction with the elements and the column distribution networks side by side.

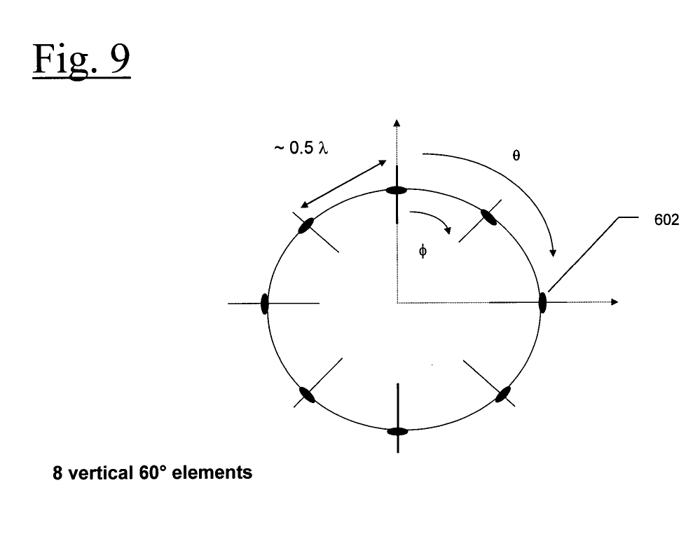

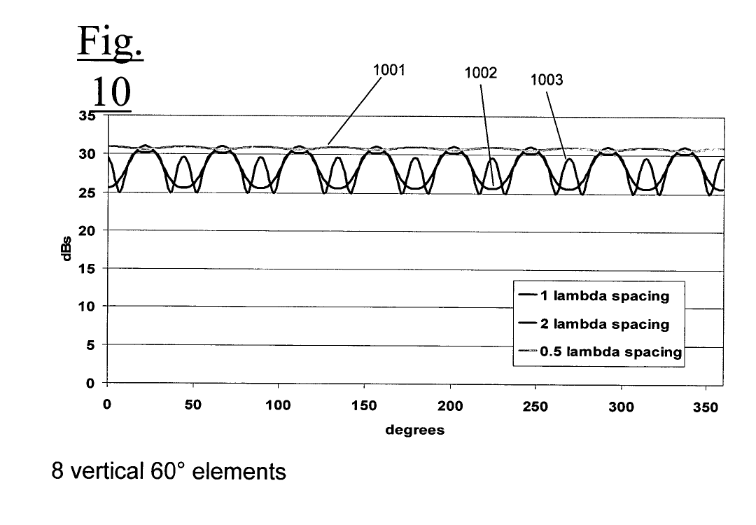

For broadcast transmission, an omni azimuth beam pattern is preferred. This can be formed from a circular array through use of “phase mode excitation”. In order to provide an omni directional beam pattern, the elements 602 of the array must be arranged close together, of the order of half wavelength spacing, as shown in FIG. 9. The reason for the selection of this spacing is shown in FIG. 10.

FIG. 10 shows a graph of the angular power of the omni directional beam for three difference elements with three different spacings. Line 1001 shows that for a spacing of 0.5 λ, the ripple on the angular power is very small, however, if the spacing is increased to 1 λ (line 1002) or 2 λ (line 1003) the ripple becomes unacceptably large. Ideally for an omni directional beam pattern, the angular power should remain constant (i.e. there should be no ripple).

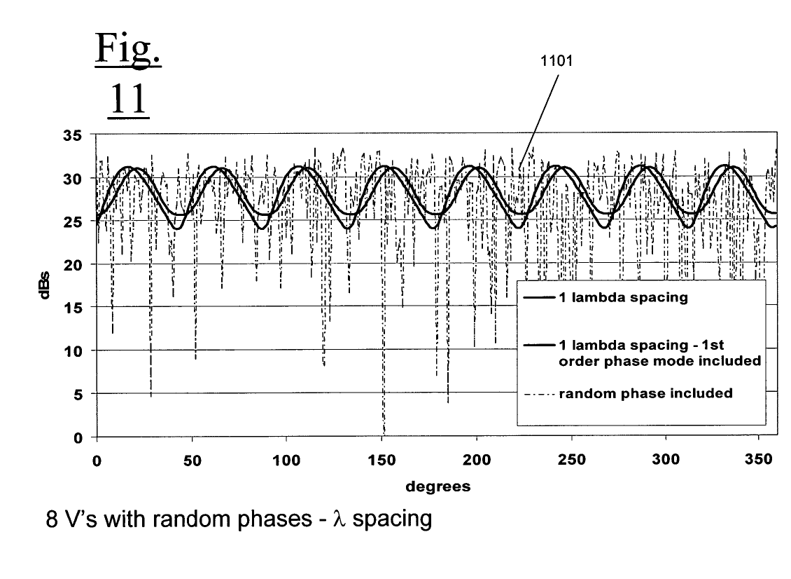

In addition to careful control of the spacing, for phase mode excitation it is necessary to carefully control the phasing to the elements and the graph in FIG. 10 assumed that the phasing was carefully controlled. If the phase is not carefully controlled, the angular power ripple becomes very large and uncontrolled, as shown in FIG. 11, line 1101.

As described earlier, within a wireless communication networks it may be necessary or desirable to have both directional transmission, from node A to node B, and broadcast transmission, from node A to any receiving equipment within the coverage area. Ideally both of these functions would be performed by the same antenna (but not concurrently), but currently this is not possible for the reasons described above.

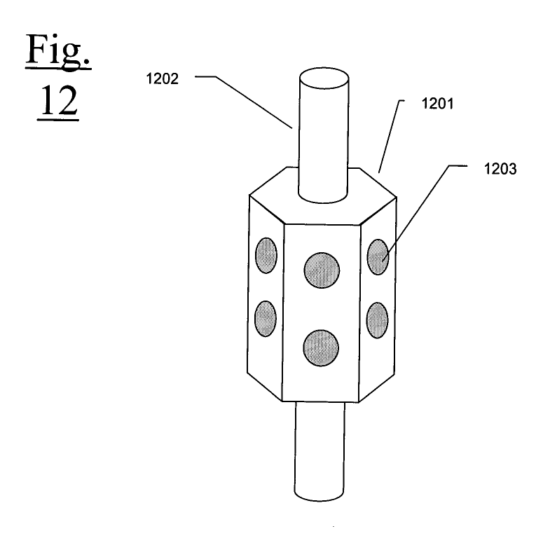

Referring to FIGS. 12-19, there is shown a second aspect of the present invention.

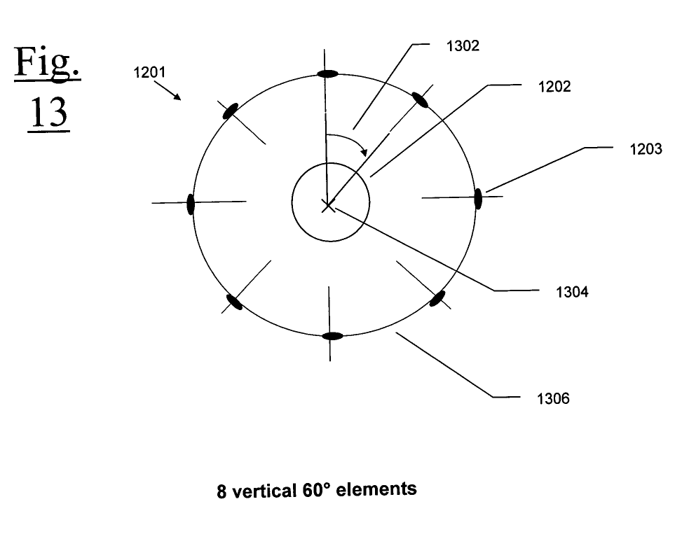

According to a second aspect of the present invention, an omni directional antenna 1201 is disclosed which can be wrapped around a structure 1202, as shown in FIG. 12. The antenna comprises a number of antenna elements 1203. As shown in FIG. 13, the elements 1203 are arranged at substantially equal angular spacing 1302 around a virtual point 1304. The elements may lie on the circumference of a circle 1306 if all the elements are substantially equidistant from the virtual point, however the elements do not need to be equidistant from the virtual point. The elements 1203 may comprise columns of individual antenna elements, as shown in FIG. 12.

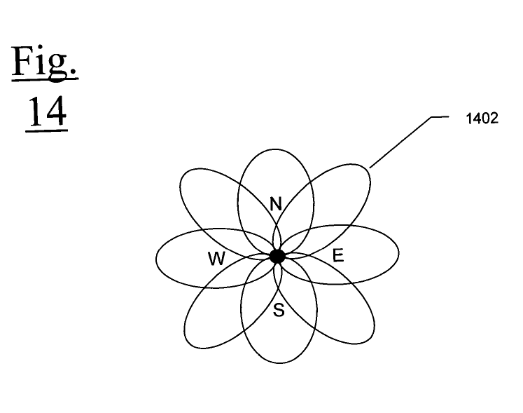

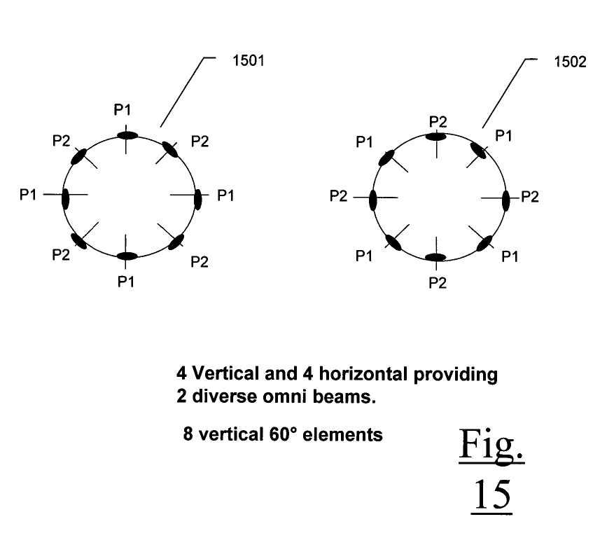

The antenna produces a number of overlapping beams 1402 as shown in FIG. 14. Each beam produced by the antenna has at least one of two orthogonal polarisations (P1 and P2 as shown in FIG. 15). Using this polarisation diversity, an omni directional beam pattern can be selected by using alternate polarisations on adjacent beams, as shown in FIG. 15. FIG. 15 shows the two possible omni directional beams 1501, 1502.

If polarisation diversity is required within the omni directional beam pattern, this can be achieved using the two different omni directional beams 1501, 1502 shown in FIG. 15. To achieve polarisation diversity, it is necessary that each of the overlapping beams 1402 can be switched between its two orthogonal polarisations referred to herein as P1 and P2.

FIG. 12 shows an antenna having 6 elements and FIGS. 13-15 show multi beam antennas each having 8 elements, these are by way of example only and other numbers of elements may be used.

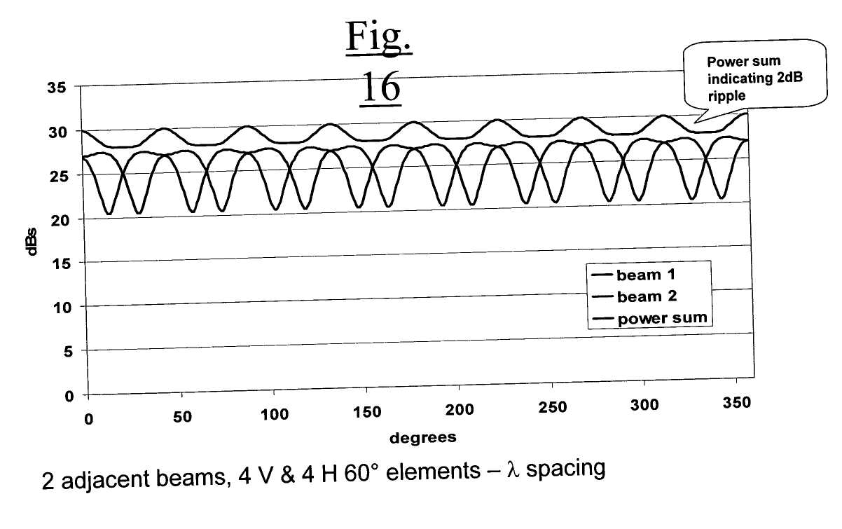

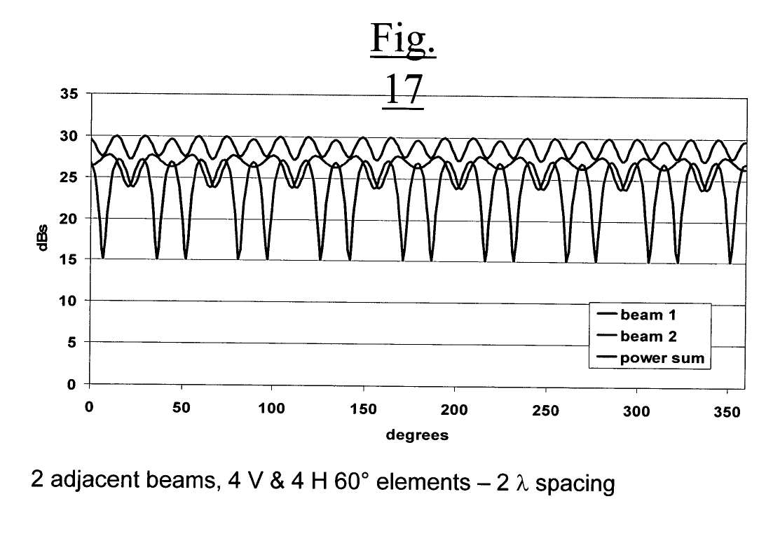

The performance of an antenna as shown in FIGS. 13-15 is shown in FIGS. 16-19. FIG. 16 shows a graph of the angular power of the omni directional beam for elements spaced by one wavelength, using the alternating polarisations as shown in FIG. 15. It can be seen that the ripple in the power is small, at only about 2 dB. FIG. 17 shows a similar graph for elements spaced by two wavelengths and again the ripple in the power is only about 2 dB.

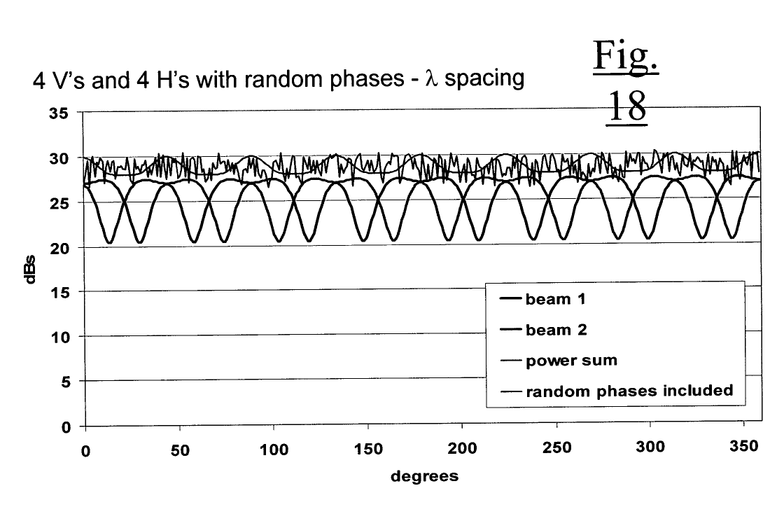

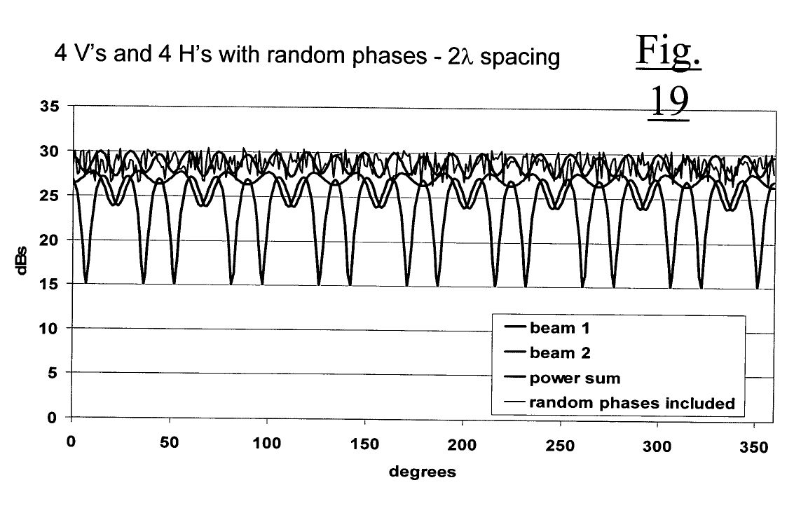

According to this invention it is not necessary to control the phasing of the elements within the antenna (FIGS. 16 and 17 assumed good control of phasing of elements) and this is clearly shown by FIGS. 18 and 19. FIG. 18 shows the effect of random phase where the elements are spaced by one wavelength (corresponding to FIG. 16) and FIG. 19 shows the same effect where the elements are spaced by two wavelengths (corresponding to FIG. 17). In both cases it can be seen that the ripple in the power is not significantly affected by the lack of phasing control.

According to a third aspect of the present invention, a single antenna is disclosed which can be switched so as to provide either a directional transmission or a broadcast transmission. The antenna comprises the antenna described above in reference to FIGS. 12-19, combined with a switching architecture described below.

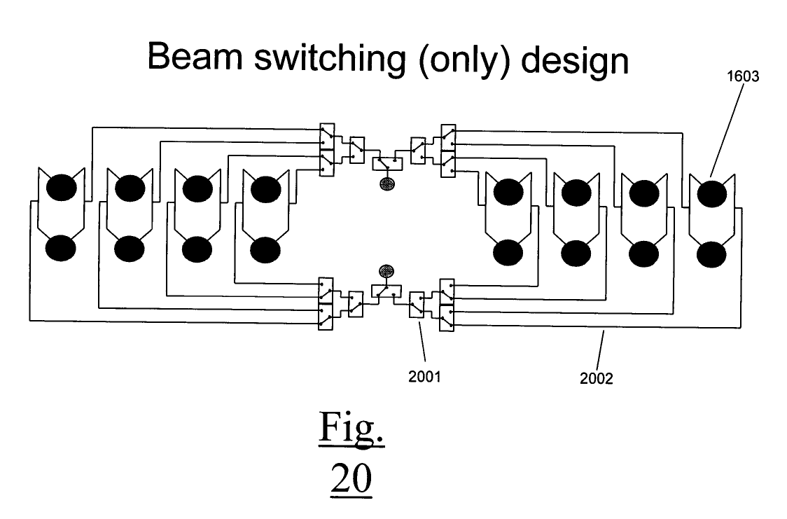

Referring to FIGS. 20-24, there is shown a fourth aspect of the present invention. Where appropriate the same reference numerals have been used throughout.

As described above, it is possible to use a single multibeam antenna to provide either directional beams or an omni directional beam pattern. According to a fourth aspect of the present invention, a switch architecture is described to allow the antenna to be switched between operation in one configuration (directional beams) and operation in the other configuration (omni directional beam pattern).

FIG. 20 shows a switch architecture suitable for use with a multibeam antenna for switched directional beams only. The architecture includes a plurality of switches 2001 joined by electrical connections 1602 to the antenna elements 2003.

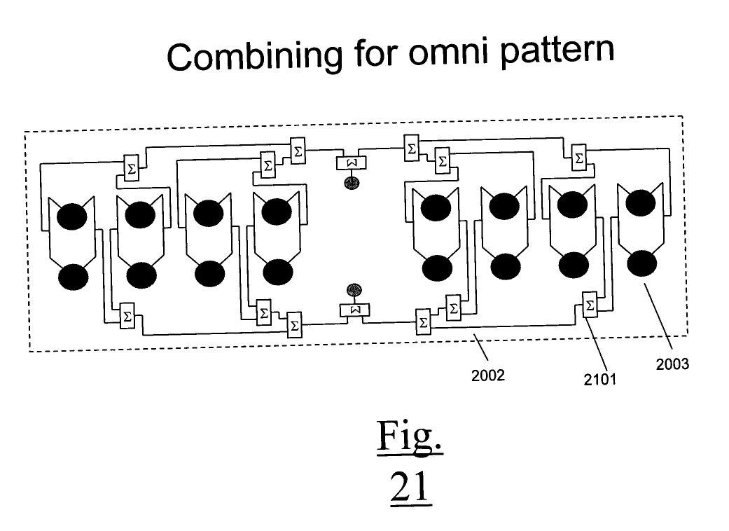

FIG. 21 shows a switch architecture suitable for use with a multibeam antenna for an omni directional beam pattern only. The architecture includes a plurality of combiners 2101 joined by electrical connections 2002, such as wires or tracks on a printed circuit, to the antenna elements 2003.

The design of FIG. 21 shows a hierarchical combination structure so that each beam has the same losses. The design also shows +/−45° polarisation inversion for each omni-combination.

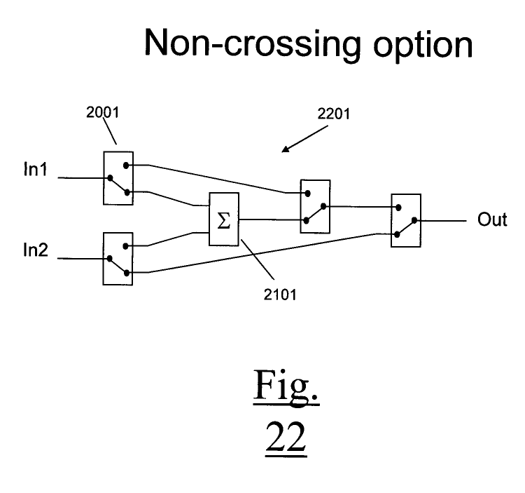

FIG. 22 shows a switching unit 2201 suitable for use with a multibeam antenna in a hierarchical structure to permit switching between the two different modes of operation; the first mode of operation being the switched directional beams and the second mode of operation being the omni directional beam pattern. The switching unit includes no track crossovers and keeps the number of elements (switches 2001 and combiners 2101) to a minimum. It is beneficial to avoid wire crossovers as it enables the antenna to be made using a single metal layer process which reduces cost. Keeping the number of switching or combining elements to a minimum also assists in minimising costs but more importantly reduces the electrical losses within the circuit. This is a repeatable unit that can be cascaded in a hierarchical switch arrangement or daisy-chain.

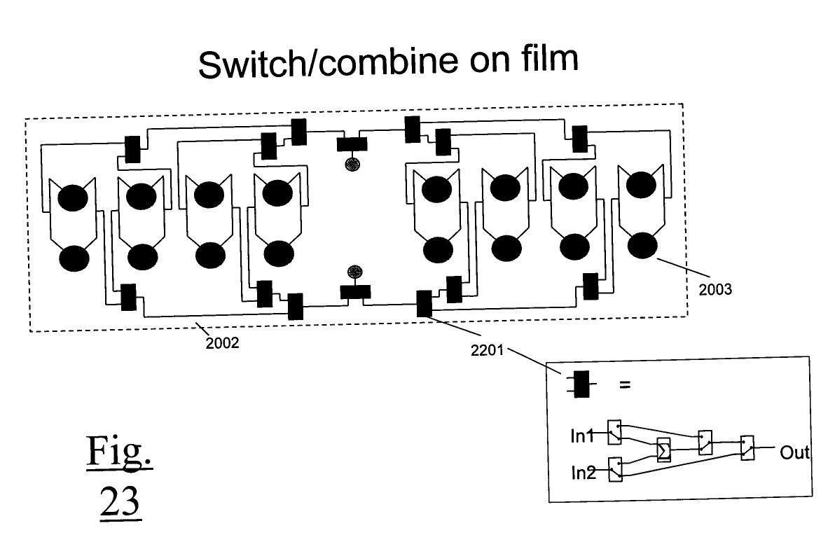

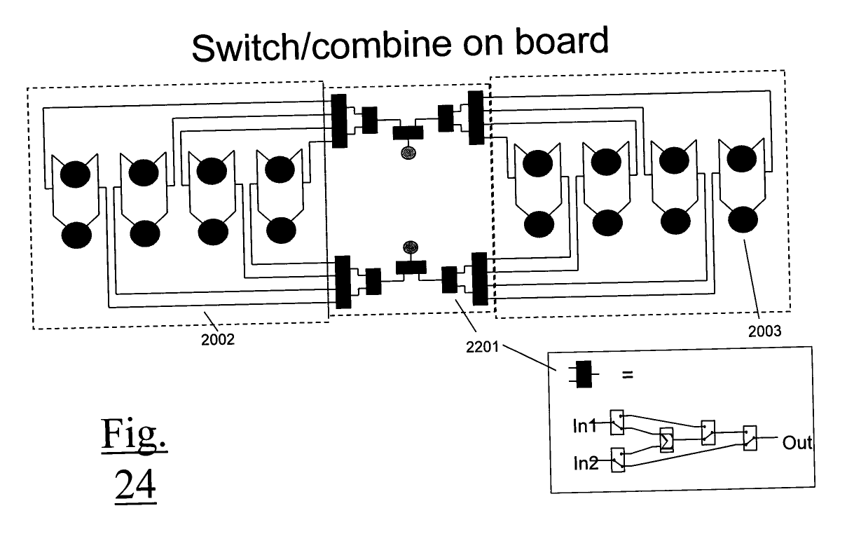

FIGS. 23 and 24 show two examples of architectures using the switching unit 2201 to connect antenna elements 2003 using electrical connections 2002, to permit switching between the two different modes of operation, (omni-directional mode and directional mode).

It will be understood that the above description of a preferred embodiment is given by way of example only and that various modifications may be made by those skilled in the art without departing from the spirit and scope of the invention.

1. An antenna forming a first plurality of fixed beams defining a coverage area, wherein each pair of adjacent fixed beams of said first plurality of fixed beams are partially overlapping and have substantially orthogonal polarizations.

2. The antenna according to claim 1 further adapted to transmit a first channel on at least two adjacent fixed beams.

3. The antenna according to claim 2 further comprising:
a respective transmitter adapted to transmit on each of said first plurality of fixed beams a respective unique composite signal, each composite signal comprising said first channel and a respective at least one unique traffic channel.

4. The antenna of claim 2 adapted to transmit CDMA signals.

5. The antenna of claim 3 further comprising a respective receiver coupled to receive a respective receive signal over each of said first plurality of fixed beams.

6. The antenna of claim 2 further adapted to receive over a second plurality of fixed beams comprising a corresponding fixed beam for each fixed beam of said first plurality of fixed beams which is substantially co-extensive with the fixed beam of the first plurality of fixed beams and has a respective polarization which is substantially orthogonal to the polarization of the fixed beam of the first plurality of fixed beams.

7. The antenna of claim 6 wherein the respective polarization of each of the first and second plurality of fixed beams is one of two substantially orthogonal polarizations.

8. The antenna of claim 7 further comprising a first antenna array and a second antenna array, the first antenna array being adapted to produce each fixed beam of said first and second plurality of fixed beams having a first of said two substantially orthogonal polarizations and the second antenna array being adapted to produce each fixed beam of said first and second plurality of fixed beams having a second of said two substantially orthogonal polarizations.

9. The antenna of claim 8 further comprising a first multiple fixed beam former connected to the first antenna array and a second multiple fixed beam former connected to the second antenna array.

10. The antenna of claim 8 further comprising a fixed beam forming matrix connected to the first antenna array and the second antenna array.

11. The antenna of claim 6 further comprising:
a respective receiver coupled to receive for each of said first and second pluralities of fixed beams a respective receive signal over the fixed beam.

12. The antenna of claim 8 further comprising:
a respective receiver coupled to receive for each of said first and second pluralities of fixed beams a respective receive signal over the fixed beam.

13. The antenna of claim 11 further comprising for each pair of fixed beams comprising a fixed beam of said first plurality of the corresponding fixed beam of the second plurality of antennas, a respective combiner adapted to perform diversity combining of the receive signals received over the pair of fixed beams.

14. The antenna of claim 12 further comprising for each pair of fixed beams comprising a fixed beam of said first plurality of the corresponding fixed beam of the second plurality of antennas, a respective combiner adapted to perform diversity combining of the receive signals received over the pair of fixed beams.

15. The antenna of claim 2 further comprising a single dual polarization antenna array adapted to providing said first plurality of fixed beams defining said coverage area, with each pair of adjacent fixed beams of said plurality of fixed beams partially overlapping and having substantially orthogonal polarizations.

16. The antenna of claim 6 comprising a dual polarization array adapted to produce all of the beams of the first and second pluralities of beams.

17. A method comprising:
transmitting a first channel on at least two adjacent fixed beams of a first plurality of fixed beams defining a coverage area, with each pair of adjacent fixed beams of said plurality of fixed beams partially overlapping and having substantially orthogonal polarization.

18. The method of claim 17 further comprising:
transmitting on each of said first plurality of fixed beams a respective unique composite signal, each composite signal comprising said first channel and a respective at least one unique traffic channel.

19. The method of claim 17 wherein the first channel is a CDMA signal.

20. The method of claim 18 further comprising:
receiving a respective receive signal over each of first said plurality of fixed beams.

21. The method of claim 18 further comprising:
receiving a respective receive signal over each of a second plurality of fixed beams comprising a corresponding fixed beam for each fixed beam of said first plurality of fixed beams which is substantially co-extensive with the fixed beam of the first plurality of fixed beams, and has a respective polarization which is substantially orthogonal to the polarization of the fixed beam of the first plurality of fixed beams.

22. The method of claim 21 wherein the respective polarization of each of the first and second plurality of fixed beams is one of two substantially orthogonal polarizations.

23. The method of claim 22 further comprising:
receiving a respective receive signal over each of said first plurality of fixed beams.

24. The method of claim 23 further comprising:
performing, for each pair of fixed beams comprising a fixed beam of said first plurality of the corresponding fixed beam of the second plurality of antennas, diversity combining of the receive signals received over the pair of fixed beams.

25. An antenna as claimed in claim 1 for forming an omni directional beam comprising a antenna arranged around a structure, wherein each said element or collection of elements forms one of said first plurality of beams.

26. An antenna as claimed in claim 25 wherein each said beam is a directional beam.

27. An antenna as claimed in claim 26 wherein each said element is arranged at substantially equal angular spacing around said structure.

28. An antenna as claimed in claim 26 capable of forming a polarisation diverse omni directional beam, further comprising a switch element capable of changing the polarisation of each directional beam between two orthogonal polarisations.

29. An antenna arrangement comprising:
a plurality of antenna elements arranged around a structure; and
a switching element for switching between a first and second beam arrangement;
wherein said first beam arrangement is a directional multiple beam pattern and said second beam arrangement is an omni directional beam pattern.

30. An omni directional beam pattern comprising:
a plurality of beams formed by an antenna arranged around a structure,
and wherein adjacent beams have orthogonal polarisation.

31. A complex switch for switching between a first and second input and a sum of said first and second inputs wherein the switch includes four switching elements and a combining element, arranged with no crossover portions.

32. A method of forming an omni directional polarisation diverse beam pattern comprising the steps of:
forming a plurality of beams from an antenna arranged around a structure;
controlling the beams such that adjacent beams have orthogonal polarisations.
